(19) United States
(12) Patent Application Publication
(10) Pub. No.: US 2011/0280788 A1
(43) Pub. Date: Nov. 17, 2011

(54) Method of Processing Carbon Dioxide Gas

(76) Inventor: Anthony J. Perrotta, Boalsburg, PA (US)

(21) Appl. No.: 12/780,419

(22) Filed: May 14, 2010

(51) Int. Cl. C01B 31/24; C01B 31/02; C01B 3/12; C01B 31/18

(52) U.S. Cl. 423/418.2; 423/419.1; 423/445 R; 423/655

(57) ABSTRACT

The present invention relates generally to a method for processing carbon dioxide gas (“CO₂”). The method includes introducing a solution which includes a cation and a hydroxide and/or oxide to the CO₂ to form a cation-containing carbonate salt; reacting the cation-containing carbonate salt with an acidic solution including a rare earth element to form a substantially solid, ionic rare earth element-containing carbonate salt material, the rare earth, cation-containing carbonate being substantially stable in the acidic solution such as to resist substantial formation of compounds selected from the group consisting of oxide, hydroxide and mixtures thereof; separating the rare earth element-containing carbonate salt material from the acidic solution; and reducing the rare earth element-containing carbonate salt material to a carbon-containing compound selected from the group consisting of carbon monoxide gas, elemental carbon and mixtures thereof.

### BACKGROUND OF THE INVENTION

1. Field of the Invention

The present invention generally relates to a method of processing carbon dioxide gas.

2. Description of the Prior Art

Carbon dioxide gas (“CO₂”) is produced as a by-product in manufacturing various products. The CO₂ is typically released into the atmosphere. The release of CO₂ into the atmosphere has the potential to evolve into a significant environmental challenge. For example, the accumulation of CO₂ in the atmosphere is increasingly being linked to global climate-warming. Further, there are projections of continued warming in the absence of effectively managing and reducing the amount of CO₂ released into the atmosphere. It is generally desirable to sequester CO₂ produced during manufacturing processes in order to reduce the release of this gas into the atmosphere.

There have been various efforts made throughout the world to curtail CO₂ emissions. Features of these activities include separation, collection and storage of a significant fraction of the CO₂ that is produced and released into the atmosphere. For example, the CO₂ could be pumped into caverns and wells where it would be stored. Another example is to produce a carbonate-containing solid from the CO₂. These approaches address the capture of CO₂ to prevent it from being released into the atmosphere; however, do not provide a mechanism to re-use or recycle the CO₂ such that it can be employed as a resource in other processes.

It is desired to reduce the levels of CO₂ released into the atmosphere and to provide a mechanism for re-using or re-cycling the CO₂ for use in the production of various other products.

### SUMMARY OF THE INVENTION

In one aspect of the present invention, a method for processing carbon dioxide gas (CO₂) is provided. The method includes (a) introducing a solution which includes a cation and a compound selected from the group consisting of hydroxide, oxide and mixtures thereof, to the CO₂ to form a cation-containing carbonate salt; (b) reacting the cation-containing carbonate salt with an acidic solution including an anion and a rare earth element to form a substantially solid, ionic, rare earth element-containing carbonate salt material, the rare earth element-containing carbonate salt material being substantially stable in the acidic solution such as to resist substantial formation of compounds selected from the group consisting of hydroxide, oxide, and mixtures thereof; (c) separating the rare earth element-containing carbonate salt material from the acidic solution; and (d) reducing the rare earth element-containing carbonate salt material to a carbon-containing compound selected from the group consisting of carbon monoxide gas, elemental carbon and mixtures thereof.

In step a, the cation can be ammonium and the cation-containing carbonate salt can be ammonium carbonate.

In step b, the rare-earth element can be selected from the group consisting of scandium, yttrium, lanthanoids and mixtures thereof. Further, the lanthanoids can be selected from the group consisting of lanthanum, cerium, praseodymium, neodymium, promethium, samarium, europium, gadolinium, terbium, dysprosium, holmium, thulium, erbium, lutetium, ytterbium and mixtures thereof.

Further, in step b, the acidic solution can further include a cation.

Furthermore, in step b, the anion can be selected from the group consisting of chloride, nitrate, nitrite, sulfonate, sulfide, sulfate, phosphate and mixtures thereof. Moreover, in step b, in one embodiment of the present invention, the acidic solution can be cerium chloride, the cation-containing carbonate salt can be ammonium carbonate and the rare earth element-containing carbonate salt material can be cerium carbonate.

The proportion of cerium chloride to ammonium carbonate can be such as to resist substantial precipitation of ammonium chloride.

Step b can further include a reactant comprising a compound selected from the group consisting of magnesium chloride, magnesium sulfate, praseodymium chloride, praseodymium sulfate and mixtures thereof.

Moreover, step b can further comprise the presence of a non-rare earth element to form a substituted rare earth element-containing carbonate salt material. The non-rare earth element can be an alkaline earth metal. The alkaline earth metal can be magnesium.

The method can further include adding water to the carbon monoxide from step d to form hydrogen.

In step d, a rare earth element oxide can be formed. The rare earth element oxide can be substantially dissolved in an acidic solution. The rare earth element oxide can include a rare earth element selected from the group consisting of cerium, praseodymium and mixtures thereof. The dissolving can be conducted in the presence of a non-Ce oxide participating in a reduction-oxidation (redox) reaction to reduce CO₂ and to reduce the concentration of acid needed to dissolve the Ce oxide. An alkaline earth metal can be partially substituted for a rare earth element. The presence of the alkaline earth metal may not participate in the redox reaction to reduce CO₂ but may reduce the concentration of acid needed to dissolve the rare earth element oxide.

In another aspect of the present invention, the carbon-containing compound processed according to the method described above can be reacted with an iron-containing compound selected from the group consisting of iron oxide, iron hydroxide, iron oxyhydroxide and mixtures thereof, to form iron carbonate.

In a further aspect of the present invention, a method of forming iron carbonate in-situ is provided. The method includes storing CO₂ gas in an underground storage recess, and introducing an iron-containing compound selected from the group consisting of iron oxide, hydroxide, and mixtures thereof, to react with the CO₂.

It is an object of the present invention to provide a method for effectively capturing CO₂ to reduce or prelude its release into the atmosphere, by substantially converting the CO₂ to carbon, carbon monoxide or hydrogen. It is a further object of the present invention to convert the CO₂ into a resource that may be used in a subsequent process, such as, but not limited to, a subsequent fuel process.

### DETAILED DESCRIPTION OF THE INVENTION

The present invention relates generally to a method of processing carbon dioxide gas (CO₂). The process includes capturing CO₂ by converting it to a soluble carbonate salt; exposing the salt to a soluble source of a rare earth element to form a carbonate salt containing a rare earth element; separating the rare earth element-containing carbonate salt from solution; heating the salt to undergo an oxidation-reduction reaction that will reduce the CO₂ to a carbon-containing compound including carbon monoxide gas (CO), elemental carbon (C) or mixtures thereof, thereby producing a higher oxidation state rare earth element-containing oxide or hydroxide; separating the CO for subsequent processing.

The present invention can be employed to process CO₂ that is produced by a wide variety of processes and is not limited to use with any particular process. For ease of description, the following disclosure will illustrate processing of CO₂ produced as a by-product of a coal combustion process.

The CO₂ produced as a by-product of a coal combustion process is converted to a salt in an aqueous solution and precipitated. For example, the CO₂ can be bubbled through a column. The column can include therein a solution containing a cation and a compound such as an oxide, a hydroxide or mixtures thereof. The reaction of the CO₂ and solution can result in the formation of a cation-containing carbonate salt as a precipitate in an aqueous solution. The cation-containing carbonate salt can include, for example, cation carbonate, cation bicarbonate, hydrated cation carbonate, hydrated cation bicarbonate and mixtures thereof. This reaction can be carried out in accordance with the following reaction scheme:

CO₂(gas)+cation oxide or hydroxide(solid)→cation carbonate, cation bicarbonate, hydrated cation carbonate or hydrated cation bicarbonate(solid) or mixtures thereof+H₂O(liquid or gas) (EQN I)

The cation for use in the present invention can be selected from those known in the art. Suitable cations can include but are not limited to sodium (Na⁺), potassium (“K⁺”), hydrogen (“H⁺”), ammonium (“NH₄⁺”), calcium (“Ca²⁺”), magnesium (“Mg²⁺”), iron (“Fe²⁺”, “Fe³⁺”) and mixtures thereof. Further, suitable cations can include those that will form a carbonate that is (i) sufficiently soluble in an aqueous solution to permit it to convert to a carbonate salt, that is capable of reducing the carbonate in the subsequently formed carbonate salt to CO or elemental C (or mixtures thereof), and (ii) sufficiently stable in an acidic environment such as to resist the substantial formation of an oxide or hydroxide. For example, it is known that the exposure of chloride salts to basic conditions can facilitate their precipitation as oxides or hydroxides.

In EQN I, the stoichiometric coefficients of the reactants are preferably selected such that electroneutrality is maintained.

In one embodiment, the cation is ammonium and the cation-containing carbonate salt is ammonium carbonate salt in accordance with the following reaction scheme:

CO₂(gas)+2NH₄OH(soln)→(NH₄)₂CO₃(solid)+H₂O (EQN Ia)

In another embodiment, the cation-containing carbonate salt can be optionally precipitated as a solid. Precipitation as a solid permits it, for example, to be separated from solution and transported to locations convenient for reduction of the CO₂ to CO and/or elemental C. If transportation of the CO₂ is not required, e.g., reduction of the CO₂ is conducted at the same location where the CO₂ is generated, precipitation of the cation-containing carbonate salt from solution may not be performed.

This process can scrub the CO₂ from emissions that are released into the atmosphere.

The cation-containing carbonate salt is converted under acidic conditions. The conversion includes reacting the cation-containing carbonate salt with an acidic solution. The acidic solution includes an acid, an anion and a rare earth element. The rare earth element is a cation that is capable of undergoing a reduction reaction that will reduce CO₂ to CO, C or mixtures thereof. The reaction of the cation-containing carbonate salt and the acidic solution forms a substantially solid, ionic rare earth element-containing carbonate salt material. The rare earth element-containing carbonate salt material is capable of undergoing a reduction reaction that will reduce CO₂, to CO or elemental C or mixtures thereof.

Suitable acids for use in the acidic solution can include a variety of mineral and/or organic acid known in the art, for example, oxalate formate, and mixtures thereof.

Suitable anions for use in the acidic solution can be selected from those known in the art. Non-limiting examples can include chloride, nitrate, nitrite, sulfonate, sulfide, phosphate, sulfate and mixtures thereof.

Non-limiting examples of rare earth elements for use in the acidic solution can include those capable of participating in a reduction reaction, such as, scandium, yttrium, lanthanoids such as lanthanum, cerium, praseodymium, neodymium, promethium, samarium, europium, gadolinium, terbium, dysprosium, holmium, erbium, thulium, lutetium, ytterbium, terbium and mixtures thereof.

In an embodiment of the present invention, the acidic solution is cerium chloride In another embodiment, the acidic solution is magnesium, cerium chloride. In yet another embodiment, the acidic solution is praseodymium, cerium chloride.

In a further embodiment of the present invention, the rare earth element-containing carbonate salt material is cerium carbonate. In another embodiment, the rare earth element-containing carbonate salt material is magnesium, cerium carbonate. In yet another embodiment, the rare earth element-containing carbonate salt material is praseodymium, cerium carbonate.

The acidic solution can optionally further include a cation, e.g., non-rare earth elements. Suitable cations can include those described above herein.

In an embodiment of the present invention, the reaction of a cation-containing carbonate salt and a rare-earth element-, anion-, cation-containing acidic solution to form a substantially solid, ionic rare earth element-, anion-, cation-containing carbonate can be carried out in accordance with the following reaction scheme (EQN II):

Cation carbonate, bicarbonate or hydrated carbonate or bicarbonate of EQN I+rare earth element-containing anion-cation combination(solution) and acid(solution)→ionic rare earth-containing, cation-containing carbonate(solid) and substantially non-rare earth-containing cation-anion combination(solid or solution) (EQN II)

wherein the cation (i.e., non-rare earth element-containing) can include but is not limited to Na⁺, K⁺, H⁺, NH₄⁺, Ca²⁺, Mg²⁺, Sr²⁺, Fe²⁺, Fe³⁺, and mixtures thereof; the rare earth element can include, but is not limited to, scandium, yttrium, lanthanoids, and mixtures thereof; the anion can include but is not limited to chloride, nitrate, nitrite, sulfate, sulfonate, sulfide, phosphate, and mixtures thereof; and the acid can include organic acids such as but not limited to oxalate, formate, and mixtures thereof. The stoichiometric coefficients in EQN II are selected such that electroneutrality is maintained.

In another embodiment, the acidic solution can include cerium as the rare earth component and chloride as the acid component. The cerium chloride is reacted with an ammonium carbonate in aqueous solution to precipitate cerium carbonate in accordance with the following reaction scheme:

2CeCl₃(solid or soln)+3(NH₄)₂CO₃(solid or soln)→Ce₂(CO₃)₃.nH₂O(solid)+6NH₄Cl(soln) (EQN IIa)

wherein n represents a number from 0 to 6 and may be dependent on temperature and relative humidity.

In a further embodiment, the proportions of reactants can be adjusted such as to resist the substantial formation of the cation-anion combination, for example, the extent of dilution can be adjusted such that precipitation of the cation-anion combination is resisted by selecting concentrations of the cation-anion combination which do not substantially exceed its solubility product. In regards to EQN IIa, the proportions of CeCl₃ and (NH₄)₂CO₃ can be adjusted such as to resist the substantial precipitation of NH₄Cl.

In alternate embodiments, substituted rare earth element-containing carbonate salt material can be produced in accordance with the present invention by adding a reactant containing a non-rare earth element, such as, but not limited to, an alkaline earth metal. The non-rare earth element can be present in an acidic solution and/or present in combination with an anion and/or cation. For example, a non-rare earth element-containing acidic solution can include an acid and optionally the presence of an anion and/or cation. Suitable acids, anions, and cations can be selected from those previously described herein.

In an embodiment, the non-rare earth element-containing acidic solution (second acidic solution) is reacted with the acidic solution containing a rare earth element and the cation-containing carbonate salt (first acidic solution) to form a double salt rare earth-containing, cation-containing carbonate according to the following reaction scheme:

Cation carbonate, bicarbonate or hydrated carbonate or bicarbonate of EQN I+rare earth element-containing anion-cation combination(solution)+non-rare earth element containing anion-cation combination and acid(solution)→ionic rare earth-containing, cation-containing carbonate(solid) and substantially non-rare earth-containing cation-anion combination(solid or solution) (EQN III)

wherein the cation (i.e., non-rare earth element-containing) can include but is not limited to Na⁺, K⁺, H⁺, NH₄⁺, Ca²⁺, Mg²⁺, Sr²⁺, Fe²⁺, Fe³⁺, and mixtures thereof; the rare earth element can include, but is not limited to, scandium, yttrium, lanthanoids, and mixtures thereof; the anion of the acid can include but is not limited to chloride, nitrate, nitrite, sulfate, sulfonate, sulfide, phosphate, and mixtures thereof; the acid can include organic acids such as but not limited to oxalate, formate, and mixtures thereof; and any acidic compound produced as a result of the combustion of coal. The values of the stoichiometric coefficients in EQN III are selected such that electroneutrality is maintained.

The proportions of the rare earth-containing anion-cation combination and non-rare earth containing anion-cation combination (see EQN III) can be adjusted to ensure undersaturation with respect to any non-rare earth element-containing carbonate salt or bicarbonate such that the rare earth containing carbonate or bicarbonate is preferentially formed. For example, substituted cerium carbonates can be produced. The resulting product can include a double salt, such as but not limited to MgCe₂(CO₃)₄ (Sahamalite) which can be produced by reacting Mg²⁺(aq) and Ce³⁺(aq) as chlorides in an acidic solution in accordance with the following reaction scheme:

2CeCl₃(solid or soln)+MgCl₂(solid or soln)+4(NH₄)₂CO₃(solid or soln)→MgCe₂(CO₃)₄(solid)+8NH₄Cl(soln) (EQN IV)

The concentrations of CeCl₃ and MgCl₂ may be adjusted to ensure undersaturation such that MgCe₂(CO₃)₄(solid) is formed rather than Ce₂(CO₃)₃(solid) and MgCO₃(solid) being formed.

In an alternate embodiment, the product may in the form of be a solid solution, such as PrₓCe₍₂₋ₓ₎(CO₃)₃, which can be produced by reacting a Pr³⁺(aq) and Ce³⁺(aq) as chlorides in an acidic solution in accordance with the following reaction scheme:

(2−x)CeCl₃(solid or solution)+xPrCl₃(solid or solution)+3(NH₄)₂CO₃(solid or solution)→PrₓCe₍₂₋ₓ₎(CO₃)₃(solid)+6NH₄Cl(aq) (EQN V)

wherein x represents a number in the range of from 0.05 to 0.90 and wherein in one embodiment, x is 0.25.

The rare earth containing carbonates, such as but not limited to, cerium carbonates and substituted cerium carbonates, are stable in acidic solution. (For example, see Table V on page 748 in American Mineralogist, Vol. 38, (1953) which shows that Sahamalite is insoluble in boiling 1 N HCl.)

In the present invention, the substantially solid, ionic rare earth element-containing carbonate salt precipitate is separated from the cation-containing solution. For example, in accordance with formulas IIa, IV and V, respectively, the Ce₂(CO₃) (solid), the MgCe₂(CO₃)₄ (solid), and the PrₓCe₍₂₋ₓ₎(CO₃)₃ (solid) can be separated from the ammonium chloride solution. The separation can be accomplished by any conventional mechanism known in the art, such as but not limited to, washing. The washing process can be conducted using water, sulfuric acid or any other known compound typically used. It is expected that if washing of the precipitate is incomplete, a trace amount of chloride may be present with the carbonate which could result in the formation of chlorine (Cl₂) or the evolution of hydrochloric acid (HCl) in subsequent steps of the process.

Following separation, the substantially solid, ionic rare earth element-containing carbonate salt precipitate is reduced to CO or elemental C or a mixture thereof, by decomposing the rare earth-containing carbonate salt, coupled with oxidizing the rare earth element to form a rare earth oxide. The rare earth element-containing carbonate salt precipitate is heated in a vacuum (i.e., in the absence of oxygen). The temperature can vary depending on the compounds employed, such as the particular rare earth element selected. In non-limiting embodiments, the rare earth-containing, carbonate salt precipitate is heated to a temperature within the range of about 200 to 700° C., or 200 to 600° C., or 400 to 700° C., or 400 to 600° C., in vacuum. In another embodiment, decomposition of Ce₂(CO₃)₃.8H₂O and of Ce(OH)CO₃.xH₂O is carried out in the absence of oxygen at temperatures within the range of about 400 to 700° C. and results in quantitative oxidation to CeO₂ by CO₂ and H₂O evolves from the carbonates. The gases which form are CO, H₂ and traces of CH₄. [Cited in Padeste, Cant and Trimm, Catalysis Letters 24, 95-105 (1994)]. The Ce₂(CO₃)₃.4.5H₂O dehydrates down to Ce₂(CO₃)₃ prior to its decomposition and prior to the onset of the reduction reactions as shown below.

Ce₂(CO₃)₃(solid)+heat→2CeO₂(solid)+CO(vapor)+2CO₂(vapor) (EQN VI)

Dry MgCe₂(CO₃)₄(solid)+heat→2CeO₂(solid)+2CO(vapor)+MgO(solid)+2CO₂(vapor) (EQN VII)

The rare earth element oxide formed (e.g., CeO₂) can be reduced and resolubilized by substantially dissolving the rare earth element oxide in an acidic solution. The acidic solution can include an acid selected from a variety of acids known in the art including those disclosed herein. For example, the acid can be selected from hydrochloric acid (HCL), sulfuric acid or mixtures thereof. The rare earth element oxide includes a rare earth element which can be selected from those disclosed herein. In an embodiment, the rare earth element is selected from cerium, praseodymium or mixtures thereof. In another embodiment, HCL is used in accordance with the following reaction schemes.

2CeO₂(solid)+6HCl→2CeCl₃(soln)+3H₂O+½O₂(vapor) (EQN VIII)

2CeO₂(solid)+MgO(solid)+8HCl→2CeCl₃(soln)+MgCl₂(soln)+4H₂O+½O₂(vapor) (EQN IX)

Not intending to be bound by any theory, dissolution of some rare earth oxides, such as but not limited to, CeO₂, can be difficult to achieve (Simon Cotton: Lanthanides and Actinides Oxford Univ Press, 1991, page 71). In an embodiment, dissolution can be conducted in the presence of a non-Ce oxide. The non-Ce oxide participates in a reduction-oxidation (redox) reaction to reduce CO₂ and to facilitate dissolution of the Ce oxide by reducing the concentration of acid needed to dissolve the Ce oxide. For example, PrO₂ is readily soluble in acid. Thus, dissolution of some rare earth oxides, such as but not limited to, CeO₂, can be improved by employing a (Ce,Pr)O₂ solid solution. Therefore, use of a (Ce,Pr)O₂ solid solution, in which there are Ce—O—Pr linkages, can facilitate dissolution of CeO₂ in acid. Further, Pr₂O₃ can be oxidized to PrO₂. In one embodiment, (Ce,R)O₂ solid solution, whether a terminal or complete solid solution, is used. R can include elements capable of participating in reduction reactions that reduce CO₂ and enhance the dissolution of Ce-containing oxides or hydroxides. In a preferred embodiment, R is praseodymium. The (Ce,R)O₂ solid solution can facilitate the dissolution of Ce to form an aqueous solution containing Ce as a chloride, as a sulfate or as another anion. In a preferred embodiment, chloride and sulfate solutions are employed as the anions.

In alternate embodiments, rare earth elements which form solid solutions with CeO₂, but that may or may not participate in reduction reactions, can be used to facilitate solubilization of Ce-containing oxides. Non-limiting examples can include terbium, scandium, yttrium, lanthanoids such as lanthanum, neodymium, promethium, samarium, europium, gadolinium, dysprosium, holmium, erbium, thulium, lutetium, and mixtures thereof. In one embodiment, terbium is employed.

In another embodiment, the presence of an alkaline earth metal can be employed as a partial substitute for the rare earth element. Not intending to be bound by any particular theory, the alkaline earth metal does not participate in a redox reaction to reduce CO₂ but does contribute to dissolution of the rare earth element oxide by reducing the concentration of acid needed to dissolve the rare earth element oxide. The alkaline earth metal can include those disclosed herein. Further, in one embodiment, the alkaline earth metal is magnesium (Mg).

It is believed that cerium (Ce) is a strong reducing agent such that in addition to the formation of CO, an amount of elemental C may also form.

The CO gas generated from the solids produced then can be separated using conventional mechanisms known in the art. In one embodiment, the CO gas is separated by employing a water gas shift reaction to produce hydrogen according to the following reaction scheme.

CO+H₂O→H₂+CO₂ (EQN X)

The CO₂ gas produced can be separated using conventional mechanisms known in the art. In one embodiment, the CO₂ gas is separated by solidification. The CO₂ gas can be reduced to carbon monoxide (e.g., CO+O) or to elemental carbon (e.g., C+O₂).

In another embodiment, the CO₂ can be reacted to produce methane by photocatalysis according to the following reaction scheme:

CO₂+4H₂→CH₄+2H₂O (EQN XI)

In yet another embodiment, the method of the present invention is employed to process CO₂ generated from an aluminum manufacture process. The CO₂ is converted to a carbon-containing compound selected from CO, elemental C or mixtures thereof, in accordance with the description provided above herein. The carbon-containing compound is reacted with an iron-containing compound selected from iron oxide, iron hydroxide, iron oxyhydroxide and mixtures thereof, to form an iron carbonate. For example, the resultant CO is reacted with Fe₂O₃ according to the following reaction scheme:

Fe₂O₃+CO→2FeO+CO₂ (EQN XII)

CO₂+FeO→FeCO₃ (EQN XIII)

Alternatively, CO and CO₂ are reacted with 2FeOOH according to the following reaction scheme:

CO+CO₂+2FeOOH→2FeCO₃+H₂O (EQN XIV)

The source of the iron oxide and/or oxyhydroxide may be of a natural origin or a man-made origin. In an embodiment, the iron oxide and/or oxyhydroxide is provided from a waste stream, such as but not limited to, an acid mine drainage sludge. In another embodiment, the iron oxide and/or oxyhydroxide is provided as an by-industrial product, such as but not limited to, red mud produced from processing of aluminum-containing ores.

In one embodiment of the present invention, iron carbonate is formed in-situ by supplementing the iron content of underground _{CO2} storage units, such as, an underground recess or well. It has been shown (Xu, et al., Chemical Geology Vol. 207, pp. 295-308, 2005) that iron carbonate can form under the conditions of an underground storage recess or well if a source of iron is present in the storage recess or well, or if a source of iron is introduced into the storage recess or well, to react with the CO₂. The source of iron can vary and can include an iron-containing compound selected from iron oxide, iron hydroxide, iron oxyhydroxide or mixtures thereof. The iron source may be of a natural origin or a man-made origin. In one embodiment, the iron-containing compound is provided from a waste stream, such as but not limited to, acid mine drainage sludge. In another embodiment, the iron-containing compound is provided as an industrial by-product, such as but not limited to, red mud produced from processing of aluminum-containing ores. The production of iron carbonate is induced by the conditions of storage by co-pumping CO₂ and an iron oxide- or hydroxide- or oxyhydroxide-containing slurry into the underground storage. In one embodiment, the underground storage recess or well comprises a storage container.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the invention which is to be given the full breadth of the claims appended and any and all equivalents thereof.

1. A method for processing carbon dioxide gas, comprising:
a. introducing a solution comprising a cation and a compound selected from the group consisting of hydroxide, oxide and mixtures thereof, to the carbon dioxide gas to form a cation-containing carbonate salt;
b. reacting the cation-containing carbonate salt with an acidic solution comprising an anion and a rare earth element to form a substantially solid, ionic, rare earth element-containing carbonate salt material, the rare earth element-containing carbonate salt material being substantially stable in the acidic solution such as to resist substantial formation of compounds selected from the group consisting of oxide, hydroxide and mixtures thereof;
c. separating the rare earth element-containing carbonate salt material from the acidic solution; and
d. reducing the rare earth element-containing carbonate salt material to a carbon-containing compound selected from the group consisting of carbon monoxide gas, elemental carbon and mixtures thereof.

2. The method of claim 1, wherein in step a, the cation is ammonium and the cation-containing carbonate salt is ammonium carbonate.

3. The method of claim 1, wherein in step b, the rare earth element is selected from the group consisting of scandium, yttrium, lanthanoids and mixtures thereof.

4. The method of claim 4, wherein the lanthanoids includes the elements selected from the group consisting of lanthanum, cerium, praseodymium, neodymium, promethium, samarium, europium, gadolinium, terbium, dysprosium, holmium, thulium, erbium, lutetium, ytterbium and mixtures thereof.

5. The method of claim 1, wherein in step b the acidic solution further comprises a cation.

6. The method of claim 1, wherein the anion is selected from the group consisting of chloride, nitrate, nitrite, sulfonate, sulfide, sulfate, phosphate and mixtures thereof.

7. The method of claim 1, wherein the acidic solution is cerium chloride, the cation-containing carbonate salt is ammonium carbonate and the rare earth element-containing carbonate salt material is cerium carbonate.

8. The method of claim 7, wherein the proportion of cerium chloride to ammonium carbonate is such as to resist substantial precipitation of ammonium chloride.

9. The method of claim 1, wherein step b further comprises a reactant selected from the group consisting of magnesium chloride, magnesium sulfate, praseodymium chloride, praseodymium sulfate and mixtures thereof.

10. The method of claim 1, wherein step b further comprises the presence of a non-rare earth element to form a substituted rare earth element-containing carbonate salt material.

11. The method of claim 10, wherein the non-rare earth element is an alkaline earth metal.

12. The method of claim 11, wherein the alkaline earth metal is magnesium.

13. The method of claim 1, wherein, in step d, the reducing is accomplished during heating.

14. The method of claim 1, further comprising adding water to the carbon monoxide to form hydrogen.

15. The method of claim 1, wherein in step d, a rare earth element oxide is formed.

16. The method of claim 15, further comprising substantially dissolving the rare earth element oxide in an acidic solution.

17. The method of claim 15, wherein the rare earth element oxide comprises a rare earth element selected from the group consisting of cerium, praseodymium and mixtures thereof.

18. The method of claim 16, wherein the dissolving is conducted in the presence of a non-Ce oxide participating in a redox reaction to reduce CO₂ and to reduce the concentration of acid needed to dissolve the Ce oxide.

19. The method of claim 15, wherein an alkaline earth metal is partially substituted for the rare earth element.

20. The method of claim 19, wherein the presence of the alkaline earth metal does not participate in the redox reaction to reduce CO₂ but reduces the concentration of acid needed to dissolve the rare earth element oxide.

21. A method for processing carbon dioxide gas, comprising:
a. introducing a solution comprising cation and a compound selected from the group consisting of hydroxide, oxide and mixtures thereof, to the carbon dioxide gas to form a cation-containing carbonate salt;
b. reacting the cation-containing carbonate salt with an acidic solution comprising an anion and a rare earth element to form a substantially solid, ionic, rare earth element-containing carbonate salt material, the rare earth element-containing carbonate salt material being substantially stable in the acidic solution such as to resist substantial formation of compounds selected from the group consisting of oxide, hydroxide and mixtures thereof;
c. separating the rare earth element-containing carbonate salt material from the acidic solution;
d. reducing the rare earth element-containing carbonate salt material to a carbon-containing compound selected from the group consisting of carbon monoxide gas, elemental carbon and mixtures thereof; and
e. reacting the carbon-containing compound with an iron-containing compound selected from the group consisting of iron oxide, iron hydroxide, iron oxyhydroxide and mixtures thereof, to form iron carbonate.

22. A method of forming iron carbonate in situ, comprising storing CO₂ gas in an underground storage recess, and introducing into the recess an iron-containing compound selected from the group consisting of iron oxide, iron hydroxide, iron oxyhydroxide and mixtures thereof, to react with the CO₂.
